(19) United States
(12) Patent Application Publication
(10) Pub. No.: US 2025/0348369 A1
(43) Pub. Date: Nov. 13, 2025

(54) FLEXIBLE APPLICATION PROGRAMMING INTERFACE PAGINATION FRAMEWORK

(71) Applicant: Matillion Limited, Salford (GB)

(72) Inventor: Mthokozisi Darlington Moyo, Manchester (GB)

(21) Appl. No.: 18/659,227

(22) Filed: May 9, 2024

(51) Int. Cl. G06F 9/54; G06F 16/25

(52) U.S. Cl. CPC G06F 9/544; G06F 16/254; G06F 2209/543

(57) ABSTRACT

A flexible framework has been created that allows a user to use a domain specific language (DSL) to write paging logic separately from the API client that handles paging (“pager”) as implemented by a data pipeline tool/orchestrator. The framework leverages a pager programmed to construct requests to an API endpoint without knowledge of the paging strategy of the API endpoint. Instead, a user who already possesses familiarity with their chosen data source for data extraction leverages its knowledge of the data source pagination strategy to specify in the DSL the pagination parameters to be used. The pager of the data pipeline tool can be used across data sources without regard to the API pagination strategy of the data source because a parser invoked by the pager or instantiated with the parser conveys instructions to the pager which pagination parameters to extract from API responses and how to populate request messages with the extracted pagination parameters.

### BACKGROUND

The disclosure generally relates to electric digital data processing and information retrieval (e.g., CPC subclass G06F/00) and ETL procedures (e.g., CPC subclass CPC G06F/254).

ETL (extract, transform, load) is a data integration process that was introduced in the 1970s. The ETL process extracts data from multiple data sources, cleans and organizes (i.e., transforms) the extracted data for the intended use and/or target system, and loads the transformed data into a target system (e.g., data warehouse or data lake). ELT (extract, load, transform) is a similar data integration process that defers transformation until after the extracted raw data has been loaded into the target system.

The rise of cloud computing has introduced “ETL pipelines” or “data pipelines.” ETL pipeline refers to the implementations or collection of processes and tools for ETL in a cloud computing environment that involves not only multiple data sources but heterogeneous data sources. In some cases, “cloud ETL” or “cloud ELT” is used instead of data pipeline. While data pipeline and ETL pipeline are sometimes used interchangeably, some use data pipeline to refer more specifically to a data integration process that includes streaming data sources or “real-time” data sources. However, it is more common for data pipeline to refer to the processes and tools that collectively implement ETL or ELT regardless of the data sources being streaming or “real-time” data sources. “Data pipeline” suggests the flow of data over a pipeline from sources, through a series of processing steps or components that implement the processing steps, to a destination or sink. ETL data pipeline is only 1 type of data pipeline-could have streaming, batching, Lambda architecture pipeline, and Delta architecture pipeline.

### BRIEF DESCRIPTION OF THE DRAWINGS

Embodiments of the disclosure may be better understood by referencing the accompanying drawings.

FIG. 1 is a high-level diagram that shows a GUI of a data pipeline tool with connectors in a data pipeline in association with underlying processes for data extraction according to the flexible API pagination framework.

FIG. 2 is a diagram of interactions between the underlying processes and an API endpoint and data for the data extraction according to a hybrid of cursor and relative path API pagination.

FIG. 3 is a flowchart of example operations for extracting data from an API endpoint according to a flexible API pagination framework.

FIG. 4 depicts an example computer system with a flexible API pagination client framework.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### INTRODUCTION

To build a data pipeline via a graphical user interface (GUI), a user interacts with a GUI of a tool/orchestrator to arrange (e.g., drag and drop icons/symbols) and configure various data pipeline components, such as data source, data sink, and processing components. This includes configuring a connector to a data source. “Connector” refers to the configuration information and the process and/or program code that implements data extraction from a data source to a specified destination or staging area of the data pipeline. The term connector also refers to a symbol or representation within the context of a GUI. The connector typically retrieves data via an application programming interface (API) of the data source. In other words, the connector will request data according to methods/functions defined and published by the API. A connector may need to implement paging due to size of a dataset being extracted or the API requirements. While there are known API pagination strategies, data sources have API pagination strategies that deviate from these known strategies or combine them. For the known pagination strategies, the data pipeline tool/application is created with program code and/or libraries to implement the known pagination strategies. These are selected when configuring a connector for a data pipeline. This paradigm is static and does not adapt to deviations from the known pagination strategies without substantial changes to support each deviation.

### Overview

A flexible framework has been created that allows a user to use a domain specific language (DSL) to write paging logic separately from the API client that handles paging (“pager”) as implemented by a data pipeline tool/orchestrator. The framework leverages a pager programmed to construct requests to an API endpoint without knowledge of the paging strategy of the API endpoint. Instead, a user who already possesses familiarity with their chosen data source for data extraction leverages its knowledge of the data source pagination strategy to specify in the DSL the pagination parameters to be used. The pager of the data pipeline tool can be used across data sources without regard to the API pagination strategy of the data source because a parser invoked by the pager or instantiated with the parser conveys instructions to the pager which pagination parameters to extract from API responses and how to populate request messages with the extracted pagination parameters. Without the flexible API pagination framework, a new paging strategy would incur manual coding for the corresponding API, using library-specific utilities, hard-coding parameters, or employing generic tools that have significant limitations. Manually coding a custom implementation increases code maintenance and risks of errors. Use of library-specific utilities is another static, rigid solution limited to the specific pagination strategy. Hard-coding parameters suffers from inefficiency and likely results in data over-fetching or under-fetching. While generic tools aim for universality, they still require extensive configuration that is specific to a particular pagination strategy that does not adapt to alternative pagination strategies.

### Example Illustrations

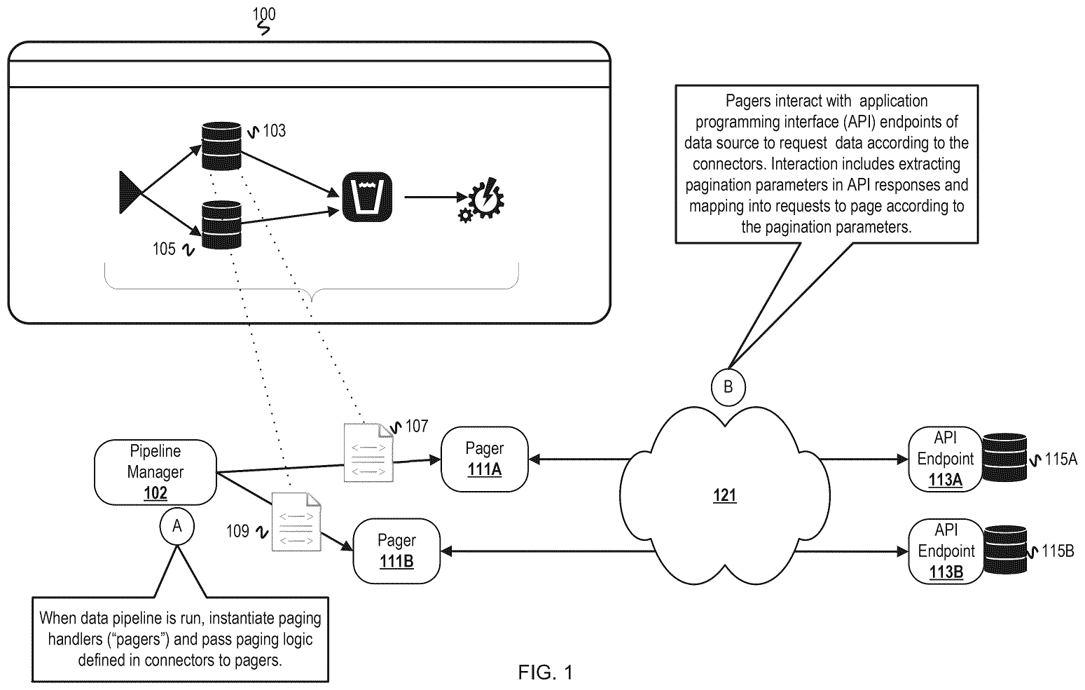

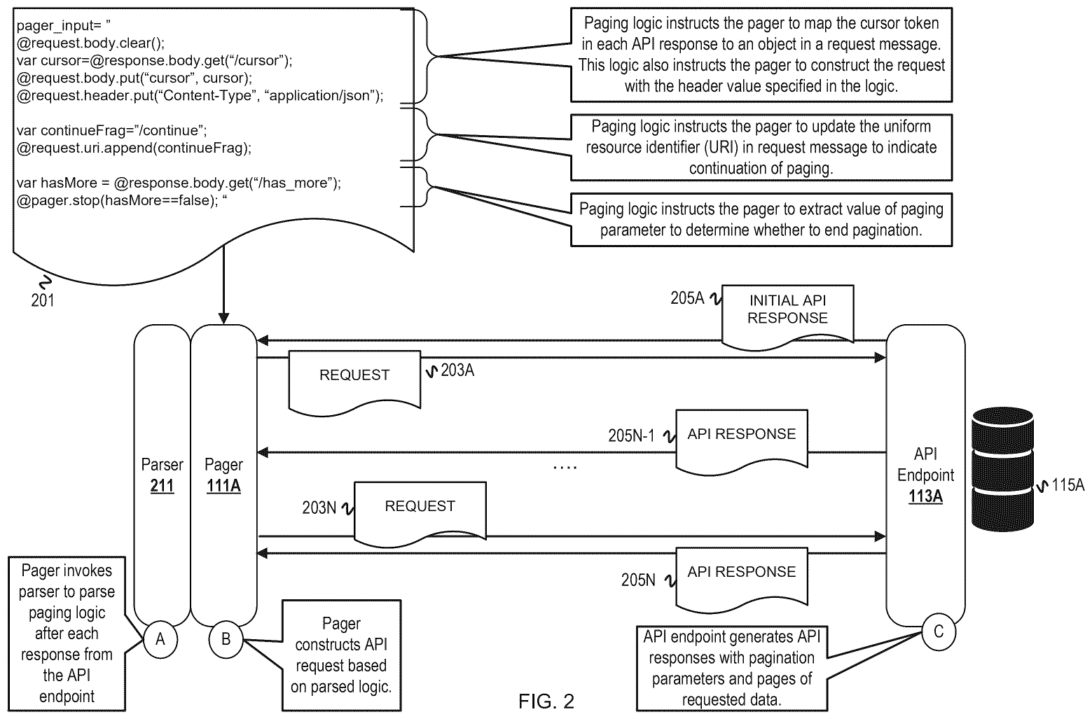

FIGS. 1 and 2 are diagrams of a data pipeline tool with a flexible framework for adaptive API pagination. FIG. 1 is a high-level diagram that shows a GUI of a data pipeline tool with connectors in a data pipeline in association with underlying processes for data extraction according to the flexible API pagination framework. FIG. 2 is a diagram of interactions between the underlying processes and an API endpoint and data for the data extraction according to a hybrid of cursor and relative path API pagination.

FIG. 1 depicts a GUI 100 of a data pipeline tool. An example data pipeline has been arranged and configured. Among the various icons depicted in the GUI 100 that represent different stages of the data pipeline are a connector symbol 103 and a connector symbol 105. The connector symbols 103, 105 represent connectors. Example configurations of the represented connectors include a uniform resource identifier (URI) of an API endpoint or API gateway, an authorization token, and data to be extracted. When the data pipeline is run or executed, the connector symbols 103, 105 represent the processes instantiated from the connector code and configurations.

FIG. 1 is annotated with a series of letters A-B, each of which represents a stage of one or more operations. These stages depicted in FIG. 1 can be considered as abstracted stages that coarsely capture the operations at a high-level to introduce the concept of the flexible API pagination framework.

At stage A, a pipeline manager 102 instantiates paging handlers/pagers 111A, 111B based on configurations of connectors represented by connector symbols 103, 105 when the data pipeline is run. Each connector has its own paging logic. The pipeline manager 102 passes paging logic 107 corresponding to the connector symbol 103 to the pager 111A. The pipeline manager 102 passes paging logic 109 corresponding to the connector symbol 105 to the pager 111B. For example, the pipeline manager 102 passes the paging logic 107, 109 as input strings to pagers 111A, 111B, respectively.

At stage B, the pagers 111A, 111B respectively interact with API endpoints 113A, 113B for data extraction according to the paging logic 107, 109. The API endpoints 113A, 113B respectively correspond to data sources 115A, 115B. The pagers 111A, 111B interact with the API endpoints 113A, 113B via network 121 (e.g., a public network) to extract data according to configuration of the corresponding connectors. The interaction includes extracting pagination parameters in API responses and mapping extracted pagination parameters into subsequent requests to extract the data in chunks or pages.

In FIG. 2, use of the flexible API pagination framework is illustrated in more detail with respect to the interactions between the pager 111A and the API endpoint 113A. The example illustration is described with example paging logic 201, which indicates a hybrid of cursor pagination and relative pagination, specifically relative path pagination. The paging logic 201 is

@request.body.clear( );
var cursor = @response.body.get(“/cursor”);
@request.body.put(“cursor”, cursor);
@request.header.put(“Content-Type”, “application/json”);
var continueFrag = “/continue”;
@request.uri.append(continueFrag);
var hasMore = @response.body.get(“/has_more”);
@pager.stop(hasMore == false);

The paging logic 201 starts with an instruction to the pager 111A to initialize a request. The paging logic 201 then identifies the pagination parameters to extract from an API response and map to request message elements. The paging logic 201 instructs the pager to map the cursor token in each API response to an object in a request message body—the “cursor” element or object of the request body. The mapping is via a variable “cursor”. The paging logic 201 also instructs the pager 111A to construct the request with the header value indicating content of the request includes a JavaScript® Object Notation (JSON) object. The paging logic 201 continues with instructions to the pager 111A to update a uniform resource identifier (URI) in a request to indicate continuation of paging. The paging logic 201 indicates this with an instruction to append a continue value/token (“/continue”) to the URI indicated in the request. In the last section, the paging logic 201 includes instructions for the pager 111A to extract a pagination parameter “/has_more” from each API response. This pagination parameter is not mapped to a request element. Instead, this pagination parameter is used to determine whether a page stop condition is satisfied. The paging logic 201 instructs the pager to stop paging if this pagination parameter satisfies the stop condition.

While the paging logic 201 includes instructions to be carried out by the pager 111A, the pager 111A uses a parser 211 to parse the paging logic 201 and determine operations to performs accordingly. FIG. 2 is annotated with letters A-C which each represent a stage of one or more operations. While these stages are more granular than those depicted in FIG. 1, they do not delve into each operation for requests and responses between an API client and API endpoint since those are known. FIG. 2 presumes that the parser 211 was instantiated with the pager 111A or instantiation of the pager 111A also instantiates the pager 211.

At stage A, the parser 211 parses the paging logic 201 after each API response from the API endpoint 113A. In some implementations, the pipeline manager 102 passes the paging logic 201 to the parser 211. The parser 211 then provides instructions to the pager 111A based on parsing the paging logic 201. In other implementations, the pager 111A receives the paging logic 201 and invokes the pager 211 to parse the paging logic 201. For instance, the parser 111A can invoke a library-defined function to parse the paring logic 201. The parser 211 may translate each of the commands or operations marked, in this example, with the “@” symbol. For instance, the parser 211 looks up a function or method of the pager 111A that maps to @request.body.get and passes “/cursor” as an argument to the function/method.

At stage B, the pager 111A constructs a request 203A for the API endpoint 113A based on the parsed paging logic 201 and continues until constructing request 203N. At this point, an initial API response 205A has already been elicited from the API endpoint 113A in response to an initial request communicated to the API endpoint 113A. Depending upon implementation, the data pipeline manager 102 may create and communicate the initial request or the pager 111A may create and communicate the initial request based on the configuration of the corresponding connector. After receipt of the initial API response 205A, the pager 111A begins processing the API responses and generating requests according to instructions from the parser 211. For instance, the pager 111A initially calls a function to instantiate a request and clear a body of the request based on the parser 211 parsing @request.body.clear ( ) The pager 111A reads a cursor token at “/cursor” in a API response based on the parser 211 instructing the pager 111A to invoke a function to read the API response at the element or object identified in the argument (i.e., “/cursor”). The pager 111A assigns the cursor token to a locally maintained variable “cursor.” The pager 111A then is instructed by the parser to write the cursor token assigned to the variable “cursor” into an element “cursor” of the request body. The pager 111A is then instructed by the parser 211 to append “/continue” to the URI that was provided in the API response. This indicates to the API endpoint 113A to continue paging the next page to the requestor.

At stage C, the API endpoint 113A generates API responses with pagination parameters and pages of the requested data. The API endpoint 113A generates the initial API response 205A with a cursor token and a URI with a path corresponding to the data extraction endpoint. Each of the subsequent API responses to API response 205N-1 will include a different cursor token and may specify a different URI depending upon the data set that satisfies the request (e.g., data may be extracted from different paths). The API endpoint 113A may generate API response 205N with a cursor token, but also sets a response body object “/has_more” to false. The pager 111A will extract the/has more pagination parameter as instructed by the parser 211 and evaluate the stop condition defined in the paging logic 201. Since the stop condition is satisfied, the pager 111A will stop paging and indicate to the pipeline manager 102 that data extraction is complete.

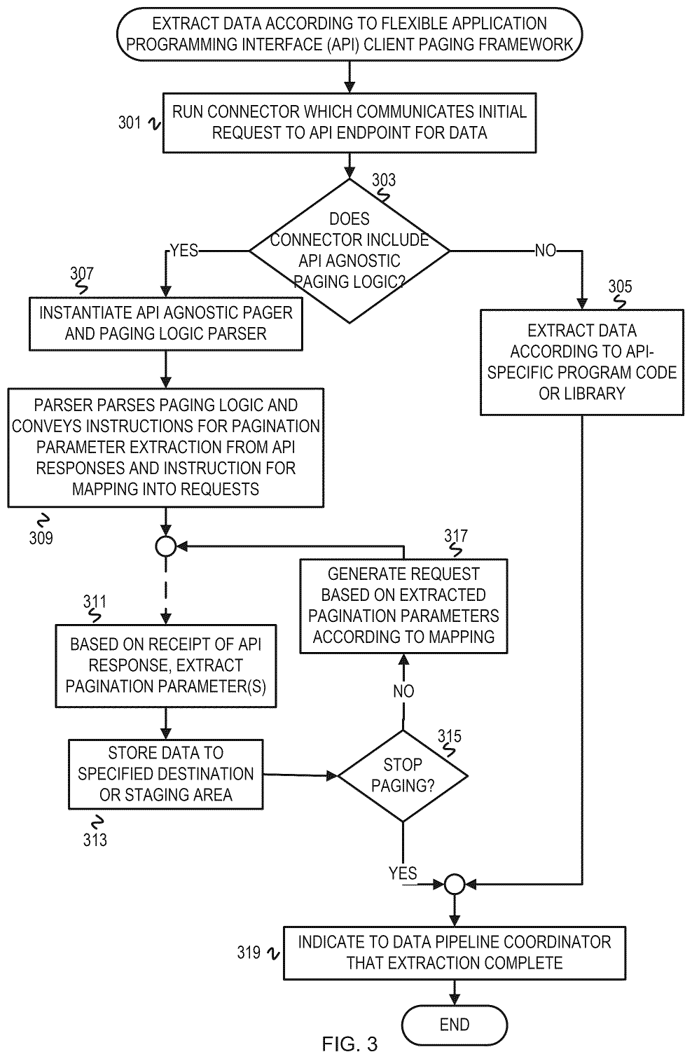

FIG. 3 is a flowchart of example operations for extracting data from an API endpoint according to a flexible API pagination framework. The depicted example operations are presumably within the context of a running data pipeline. Thus, these example operations would be performed when the data pipeline reaches the corresponding stage based on arrangement of the data pipeline. Additional operations that would occur as part of running a data pipeline are not illustrated. The example operations are described with reference to a pipeline manager, a pager, and a parser for consistency with FIGS. 1 and 2. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

At block 301, a data pipeline manager runs a connector which communicates an initial request to an API endpoint for data. Running the connector generates an initial request to the API endpoint specified in the connector. The connector also specifies criteria for the data to be extracted and a destination for storing the extracted data.

At block 303, the data pipeline manager determines whether the connector includes API agnostic paging logic. Determining whether the connector includes API agnostic paging logic can vary by implementation. This can be done by detected the DSL used for paging logic in the flexible API pagination framework. As another example, the data pipeline manager can determine whether a variable for this agnostic paging logic is present. While the provided examples correspond to paging strategies of APIs with custom or complex paging demands, the flexible API pagination framework can be invoked for other reasons. For instance, a user may write logic in the DSL of the flexible pagination framework that optimizes a common paging strategy. In addition, the DSL and the flexible API pagination framework can be used for the common paging strategies. If the connector includes API agnostic paging logic, then operational flow proceeds to block 307. Otherwise, operational flow proceeds to block 305. If the connector does not include API agnostic paging logic, then the data extraction of the connector runs according to API-specific programming or a library specified in the connector and implemented as part of the data pipeline tool. Operational flow proceeds from block 305 to block 319.

At block 307, the data pipeline manager instantiates an API agnostic pager and a paging logic parser. The API agnostic pager is programmed with basic API client functionality, for example generating requests and receiving responses. The paging logic parser translates or maps functions or annotations in paging logic to functions/methods that can be executed by the API agnostic pager.

At block 309, the parser parses paging logic of the connector. The parser conveys instructions indicated in the paging logic to the pager. The instructions will vary depending upon the paging logic which corresponds to the pagination strategy. The instructions will at least indicate to the pager pagination parameter extraction from API responses and mapping of at least one extracted pagination parameter to an element of a request. The paging logic can also include instructions for stopping paging. Parsing the paging logic involves tokenization, syntax analysis, semantic analysis, and translation for the pager. While the syntax analysis and the semantic analysis ensure valid commands are specified in the paging logic, the translation corresponds to conveying instructions to the pager. The parser translates each valid command (e.g., a data retrieval command or a page management command) into instructions that can be performed/executed by the pager.

At block 311, the pager extracts a pagination parameter(s) from a received API response. A dashed line to block 311 represents the asynchronous aspect of transmitting and receiving communications. As mentioned previously, the initial response from the API endpoint is in response to the request transmitted at block 301.

At block 313, the pager stores the page of data in the API response to a destination or staging area specified in the connector configuration. In some cases, each page of data can be written to the specified destination. In some cases, the pages of data are aggregated in a staging area and then written to the destination.

At block 315, the pager determines whether to stop the paging. The pager evaluates a stop condition specified in the paging logic based on a value of a pagination parameter extracted from the API response. If paging is to be stopped, then operational flow proceeds to block 319. If paging is not to be stopped, then operational flow proceeds to block 317.

At block 317, the pager generates a request based on the extracted pagination parameter(s) according to the mapping specified in the paging logic. To illustrate, two additional paging logic examples are provided.

This first example paging logic implements a paging strategy that is based on offset paging but without a record count from the API endpoint.

var currentOffset = @request.query.get(“offset”);
var newOffset = currentOffset + 5;
@request.query.put(“offset”, newOffset);
var contents = @response.body.get(“/0”);
@pager.stop(contents==“”);

While a paging handler will request a next page of data according to an offset in a request, this first example paging logic increments the offset in a previous request to skip to the desired data set for retrieval. Since the pager handler is modifying the offset, the page handlers relies on determining that the first index (indicated by “/0”) of an array is empty to stop paging.

This second example of paging logic implements a cursor paging strategy

var cursor = @response.body.get(“/pages/next/starting_after”);
@request.query.put(“starting_after”, cursor);
@request.query.put(“per_page”, 150);
var totalPages = @response.body.get(“/pages/total_pages”);
var pageNumber = @response.body.get(“/pages/page”);
@pager.stop(totalPages == pageNumber);

The second paging logic indicates a stop condition based on the first API response communicating total pages to be provided. When the a page response is equal to the total pages, then paging is stopped.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in FIG. 3 could be different if the instantiated pager generates and communicates the first request to an API endpoint for a data extraction. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

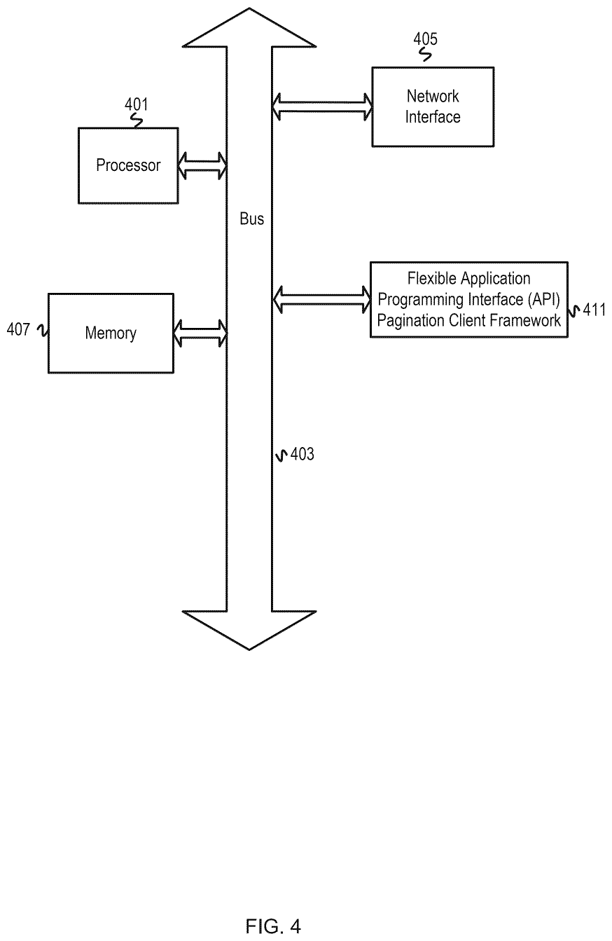

FIG. 4 depicts an example computer system with a flexible API pagination client framework. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes flexible API pagination client framework 411. The flexible API pagination client framework 411 includes program code for a parser to parse paging logic in a DSL for API agnostic paging logic and program code for a pager that can handle the basic functionality of an API client-reading API responses and constructing requests that conform to an API specification. The flexible API pagination client framework 411 passes API agnostic paging logic to a parser which translates the paging logic for a pager. The parser determines pagination parameters to extract from API responses and how to map them into requests and/or evaluate a paging stop condition. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
based on detection of a paging logic configured for a data source connector in a data pipeline, instantiating a pager to communicate with an application programming interface (API) endpoint specified in the data source connector;
communicating to the API endpoint a first request for data from the data source according to configuration of the connector;
for each of a plurality of API responses,
parsing the paging logic to determine a first set of pagination parameters for extraction from the API response and to determine mapping of at least a first of the first set of pagination parameters into a subsequent request message;
indicating to the pager the first set of pagination parameters to extract from the API response;
indicating to the pager the mapping of the first pagination parameter into a subsequent request message; and
the pager generating the subsequent request message with a value of the first pagination parameter extracted from the API response assigned to an element of the subsequent request message according to the mapping.

2. The method of claim 1, further comprising:
for each of the plurality of API responses,
determining whether a stop condition is satisfied based on a value of a second pagination parameter extracted from the API response; and
stopping paging based on determining that the stop condition is satisfied,
wherein generating the subsequent request message is based on determining that the stop condition is not satisfied.

3. The method of claim 1 further comprising, for each of the plurality of API responses, storing data in a payload of the API response to a destination or staging area.

4. The method of claim 1, wherein instantiating the pager comprises instantiating a parser.

5. The method of claim 1, wherein the pager invokes the parser after receipt of each API response.

6. The method of claim 1 further comprising communicating each subsequent request message to the API endpoint.

7. The method of claim 1, wherein the paging logic is in a human-readable data serialization language.

8. A non-transitory, machine-readable medium having program code for building a data pipeline stored thereon, the program code comprising instructions to:
instantiate an application programming interface (API) client for a connector in a data pipeline;
for each of a plurality of API responses received after requesting data extraction from a data source according to configuration of the connector,
parse paging logic of the connector to determine a first set of pagination parameters for extraction from the API response and to determine how to map at least a first of the first set of pagination parameters into a subsequent request;
indicate to the API client the first set of pagination parameters to extract from the API response and the mapping of the first pagination parameter into a subsequent request; and
generate the subsequent request message with a value of the first pagination parameter extracted from the API response assigned to an element of the subsequent request message according to the mapping.

9. The non-transitory, machine-readable medium of claim 8, wherein instructions for the API client include the instructions to generate the subsequent request message.

10. The non-transitory, machine-readable medium of claim 8, wherein the program code further comprises instructions to:
for each of the plurality of API responses,
determine whether a stop condition is satisfied based on a value of a second pagination parameter extracted from the API response; and
stop paging based on a determination that the stop condition is satisfied,
wherein the instructions to generate the subsequent request message are executed based on a determination that the stop condition is not satisfied.

11. The non-transitory, machine-readable medium of claim 8, wherein the program code further comprises instructions to, for each of the plurality of API responses, store data in a payload of the API response to a destination or staging area according to configuration of the connector.

12. The non-transitory, machine-readable medium of claim 8, wherein the program code further comprises instructions to communicate to a manager of the data pipeline completion of data extraction.

13. The non-transitory, machine-readable medium of claim 8, wherein the program code further comprises instructions to instantiate a parser for the API client, wherein the parser executes the instructions to parse the paging logic and the instructions to indicate the first set of pagination parameters to extract and the mapping.

14. The non-transitory, machine-readable medium of claim 8, wherein the program code further comprises instructions of the API client, the instructions of the of API client comprising instructions to communicate each subsequent request to an API endpoint indicated in configuration of the connector.

15. An apparatus comprising:
a processor; and
a machine-readable medium having instructions stored thereon that are executable by the processor to cause the apparatus to,
instantiate an application programming interface (API) client for a connector in a data pipeline;
for each of a plurality of API responses received after requesting data extraction from a data source according to configuration of the connector,
parse paging logic of the connector to determine a first set of pagination parameters for extraction from the API response and to determine how to map at least a first of the first set of pagination parameters into a subsequent request;
indicate to the API client the first set of pagination parameters to extract from the API response and the mapping of the first pagination parameter into a subsequent request; and
generate the subsequent request message with a value of the first pagination parameter extracted from the API response assigned to an element of the subsequent request message according to the mapping.

16. The apparatus of claim 15, wherein the machine-readable medium further has stored thereon instructions for the API client which include the instructions to generate the subsequent request message.

17. The apparatus of claim 15, wherein the machine-readable medium further has stored thereon instructions to:
for each of the plurality of API responses,
determine whether a stop condition is satisfied based on a value of a second pagination parameter extracted from the API response; and
stop paging based on a determination that the stop condition is satisfied,
wherein the instructions to generate the subsequent request message are executed based on a determination that the stop condition is not satisfied.

18. The apparatus of claim 15, wherein the machine-readable medium further has stored thereon instructions to, for each of the plurality of API responses, store data in a payload of the API response to a destination or staging area according to configuration of the connector.

19. The apparatus of claim 15, wherein the machine-readable medium further has stored thereon instructions to communicate to a manager of the data pipeline completion of data extraction.

20. The apparatus of claim 15, wherein the machine-readable medium further has stored thereon instructions to instantiate a parser for the API client, wherein the parser executes the instructions to parse the paging logic and the instructions to indicate the first set of pagination parameters to extract and the mapping.
